(19) United States
(12) Patent Application Publication
(10) Pub. No.: US 2019/0234977 A1
(43) Pub. Date: Aug. 1, 2019

(54) METHOD FOR ATTACHING A SAMPLE VESSEL RACK IN AN APPARATUS, SAMPLE VESSEL RACK AND APPARATUS FOR A SAMPLE VESSEL RACK

(71) Applicant: THERMO FISHER SCIENTIFIC OY, Vantaa (FI)

(72) Inventor: Tuomas ANTINJUNTTI, Helsinki (FI)

(21) Appl. No.: 16/312,117

(22) PCT Filed: Jun. 20, 2017
(86) PCT No.: PCT/FI2017/050461

§ 371 Date: Dec. 20, 2018

(30) Foreign Application Priority Data
Jun. 29, 2016 (FI) 20165535

(51) Int. Cl. G01N 35/02; B01L 9/06

(52) U.S. Cl. CPC G01N 35/02; G01N 2035/0441; B01L 9/06

(57) ABSTRACT

Method for attaching a sample vessel rack (1, 1′) in an apparatus (2, 2′, 23), which apparatus comprises a slot (4, 24) into which the sample vessel rack is inserted, wherein magnetic attraction force is utilized in the attachment and correct positioning of the sample vessel rack (1, 1′) into the slot (4, 24), where in the slot (4, 24) comprises a movable member (9, 9′, 28, 35), which movable member is moved to a locking position with a magnetic attraction force when the sample vessel rack (1, 1′) is in a correct position in the slot, and which movable member comprises at least one protrusion (11, 33) which protrusion sets itself in a notch (37) formed in the sample vessel rack in the locking position of the movable member. The invention also relates to such a sample vessel rack and an apparatus, and to a use of such a sample vessel rack.

### FIELD OF TECHNOLOGY

The present invention relates to sample vessel racks inserted in different kind of apparatuses, for handling and/or operating the sample vessels located in the sample vessel racks. More precisely the invention relates to attachment and proper positioning of a sample vessel rack in an apparatus.

### TECHNOLOGICAL BACKGROUND

Sample vessel or vial racks are used for storing and transferring a plurality of sample vessels as a single entity which significantly facilitates the handling of the sample vessels and the samples contained therein. The racks are also used for feeding samples in the sample vessels to an analyzing instrument, where the samples together with the sample vessels are usually removed from the rack in order to carry out the required analyzing process steps to the sample.

The sample vessel racks are generally square or triangle shaped, but other shapes are also used.

The sample vessels located in sample vessel racks typically comprise samples from different donors which are analyzed with suitable analyzer instrument. In the medical or clinical analysis of human based samples, such as blood, urine, feces etc., it is of utmost importance to prevent sample mix up which could lead to wrong analysis results being connected to the donor.

Sample vessel racks are generally inserted in the analyzing instrument through an inserting opening which is open or opened by the operator. Once the sample vessel rack is properly inserted in the analyzer instrument, the analyzer instrument moves the rack to the handling means of the instrument so that the sample vessels in the rack can be properly handled via automated sample vessel handling.

If the sample vessel rack is not properly inserted in the analyzer instrument, the automated sample handling system of the analyzer instrument will not be able to properly handle the samples, which may further cause significant problems for the analyzing process.

### SUMMARY OF THE INVENTION

Both FDA (US Food and Drug Administration) and MDD/IVD standard ISO 13485 require that patient results generated by in vitro diagnostic (IVD) instruments must be traceable back to the original patient samples and to all analytically critical components of the analyzer systems including liquid consumables and disposables used in the analyzing processes.

In the context of the present invention a microbiology laboratory may have several rooms or laboratories for different kinds of sample types. Samples from these laboratory rooms are transferred to a separate analyzing room for analysis, which analyzing room is equipped with suitable analyzer instruments and serve several different laboratory rooms.

Generally, the samples to be analyzed are prepared in a sample preparation station located at the room or rooms. The sample preparation station comprises an instrument to facilitate movement of primary samples (e.g. bacterial colony) from original sample media (e.g. agar plate, blood culture bottle) to a sample vessel in an ergonomic manner which further reduces errors.

As an example, a primary sample in an agar plate is taken to the sample preparation station and identification data of the primary sample, which is stored in a barcode, radio frequency identification (RFID) tag or other indicia, is read to the sample preparation station with a suitable reader. Once confirmation of the data input is received, for example by a visual or audio signal, a specimen sample is taken from the primary sample with a sampling device, and the primary sample is returned to its storage. Next a sample vessel is taken, and its identification data is read to the sample preparation station with a suitable reader as was done with the primary sample. The sample in the sampling tool is inserted into the sample vessel, the sampling tool is discarded and the lid or cap of the sample vessel is closed. The sample vessel together with the sample is placed in an empty position of a sample vessel rack located in the sample preparation station in a proper orientation. The sample preparation station detects the location of the newly inserted sample vessel in the sample vessel rack and connects identification data obtained from the primary sample and the new sample vessel to the location of the sample vessel in the sample vessel rack.

When the sample vessel rack contains the required number of sample vessels, the sample vessel rack is removed from the sample vessel preparation station. In one example, the removal action also activates a locking means in the sample vessel rack. The locking means prevent the removal of any of the sample vessels located in the rack when locking is activated. The sample vessel rack is then inserted into an analyzing instrument, which insertion action optionally deactivates the locking means in the sample vessel rack, allowing removal of the sample vessels from the sample vessel rack for analysis operations.

The obtained analysis results are connected to the identification data of the sample from the sample preparation station, so that each analysis result can be tracked to a single sample.

The present invention provides a novel solution for attaching the sample vessel rack when the sample vessel rack is inserted in an apparatus for the sample vessel rack, such as an analyzer instrument or a sample preparation station, which solution can be used for example in the above described process. The present invention allows, among other advantages, for proper fixing and positioning of the sample vessel rack in the apparatus, which helps to guarantee the proper automated handling of sample vessels located in the sample vessel rack with the apparatus in question.

In the method of the invention for attaching a sample vessel rack in an apparatus, which apparatus comprises a slot into which the sample vessel rack is inserted, the attachment and correct positioning of the sample vessel rack in the slot is implemented with magnetic attraction force when the sample vessel rack is inserted in the slot. The magnetic attraction force advantageously pulls and guides the sample vessel rack in the correct position, when the operator places the sample vessel rack in the area of effect of the magnetic attraction force. In the method the slot further comprises a movable member, which movable member is moved to a locking position with magnetic attraction force when the sample vessel rack is in correct position in the slot, and which movable member comprises at least one protrusion which protrusion sets itself in a notch, or in other suitable opening or hole, formed in the sample vessel rack in the locking position of the movable member. This way the movable member can lock the sample vessel rack in its proper position in the slot once the sample vessel rack has achieved this position.

In an embodiment of the method of the invention the sample vessel rack comprises protrusions and/or openings which co-operate with corresponding openings and/or protrusions in the slot together with the magnetic attraction force for attaching the sample vessel rack in the slot. These protrusion/opening pairs improve the attachment and proper positioning of the sample vessel rack in the slot of the apparatus.

In the above embodiment the movable member advantageously also causes a generation of a signal for the apparatus when the movable member is in locking position. This generation of a signal can be implemented with optical sensors, distance sensors, or other similar means, for example. The movable member may also be equipped with suitable means, such as a spring, which keeps the movable member in a released position when no magnetic attraction force is affecting the movable member, so that the possibility of an incorrect locking signal can be prevented.

In an embodiment of the method of the invention the inserted sample vessel rack comprises a locking system for locking the sample vessels at their locations in the rack, which locking is released during the insertion of the sample vessel rack in the slot.

The present invention also provides a sample vessel rack for a plurality of sample vessels, which sample vessel rack comprises a frame, which sample vessel rack comprises at least one magnet for attaching and properly positioning the sample vessel rack in an apparatus. The magnet used to create the magnetic attraction force and utilized herein can be a permanent magnet or magnetic metal piece, for example. The frame of the sample vessel rack further comprises protrusions and/or openings for attaching and properly positioning the sample vessel rack to an apparatus, and a notch for receiving at least one protrusion of a movable member for locking the sample vessel rack to an apparatus.

In the above mentioned embodiment the protrusions and/or openings may be arranged asymmetrically in the opposite sides of the sample vessel rack.

In an embodiment of the sample vessel rack of the invention the sample vessel rack has substantially triangular form in a plane perpendicular in relation to the insertion direction of the sample vessels.

The above mentioned protrusions and/or openings in the sample vessel rack and the substantially triangular form of the sample vessel rack help to guide the sample vessel rack into a proper position and orientation in the apparatus during the inserting of the sample vessel rack into the apparatus.

The present invention also provides an apparatus for a sample vessel rack, which apparatus comprises a slot for inserting the sample vessel rack, wherein the slot comprises a magnet or a magnetic metal piece which co-operates with at least one magnet or magnetic metal piece located in the sample vessel rack for attaching and properly positioning the sample vessel rack inserted in the slot. In the apparatus of the invention the magnet or magnetic metal piece is located in a movable member, which movable member comprises at least one protrusion, which at least one protrusion is located in a notch or in other suitable opening or hole in the sample vessel rack when the movable member is in a locking position.

In an embodiment of the apparatus of the invention the slot comprises openings and/or protrusions for corresponding protrusions and/or openings in the sample vessel rack for attaching and properly positioning the sample vessel rack in the slot.

In the above embodiment the movable member can also comprise means for causing the generation of a signal when the movable member is in the locking position, such as optical sensors, distance sensors or other similar means, for example. This signal can be used for informing the apparatus and/or the operator that the inserted sample vessel rack is in a proper position for further actions.

In an embodiment of the apparatus of the invention the slot comprises means for releasing locking of sample vessels in the sample vessel rack when the sample vessel rack is located in the slot. These means can be implemented with a suitable protrusion extending inside the sample vessel rack when the rack is inserted in the apparatus, which protrusion operates the locking means of the sample vessel rack via movement of the rack in relation to the apparatus, for example. Advantageously these means are also utilized for locking the sample vessel rack in vertical direction in the slot, for example by locking the tip of the sample vessel rack vertically.

In an embodiment of the apparatus of the invention the apparatus is an analyzer instrument or a sample preparation station.

The invention also provides a use of a sample vessel rack of the invention in an analyzer instrument.

The features defining a method of the invention are more precisely presented in claim 1, the features defining a sample vessel rack of the invention are more precisely presented in claim 5, and the features defining an apparatus of the invention are more precisely presented in claim 8. Use of a sample vessel rack of the invention is defined in claim 13. Dependent claims present advantageous features and embodiments of the invention.

### DRAWINGS

An exemplifying embodiment and its advantages are explained in greater detail below in the sense of an example and with reference to the accompanying figures, where

FIG. 1 shows schematically an embodiment of a sample vessel rack of the invention located in a part of an apparatus of the invention,

FIG. 2 shows schematically the bottom of the vessel rack of FIG. 1,

FIG. 3 shows schematically a cross-section of the part of the apparatus of FIG. 1,

FIGS. 4A-4C show schematically the insertion and removal of the sample vessel rack from the part of the apparatus of FIG. 1 as a cross-sectional views,

FIGS. 5A and 5B show schematically the sample vessel rack in detached and attached positions in the part of the apparatus of FIG. 1,

FIGS. 6A and 6B show schematically an alternative embodiment of a part of an apparatus of the invention with a sample vessel rack,

FIG. 6C show schematically a top view of the embodiment of a sample vessel rack for the apparatus of FIGS. 6A and 6B,

FIGS. 7A-7C show schematically another embodiment of a part of an apparatus of the invention, and

FIGS. 8A and 8B show schematically yet another embodiment of a part of an apparatus of the invention.

### DETAILED DESCRIPTION OF THE EMBODIMENT

As can be seen from the previous Drawings section, all of the figures show the same embodiment of the invention, and thus the same reference numerals are used for the same parts in different figures.

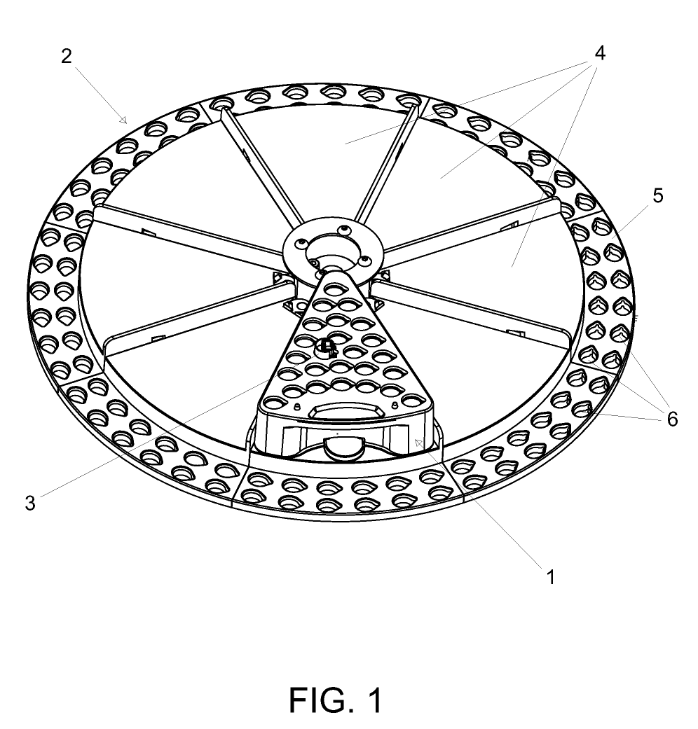

In FIG. 1 is shown a sample vessel rack 1 of the invention located in a part 2 of an analyzer instrument, which part 2 is in this embodiment a sample carousel, which is used to move the sample vessel rack together with the sample vessels 3 located in the rack to further handling and analyzing actions. The sample carousel 2 in this embodiment comprises eight slots 4 for sample vessel racks 1. The sample carousel 2 is accessible from one side for inserting the sample vessel racks 1 into the carousel and for removing racks from the carousel, but otherwise the carousel is typically located inside the analyzer instrument. The access to the sample carousel 2 can be implemented via automated hatch or door located on the side of the analyzer instrument, for example, which allows access to a single slot 4 of the carousel at a time.

In this embodiment, as can be seen from the figures, the sample carousel also comprises an edge portion 5, which edge portion comprises a plurality of openings 6, into which openings the sample vessels can be inserted without the use of the sample vessel rack.

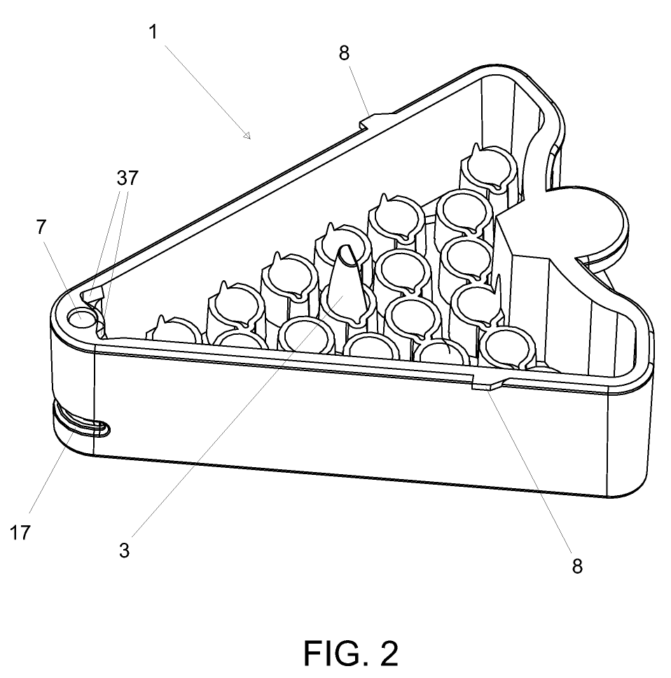

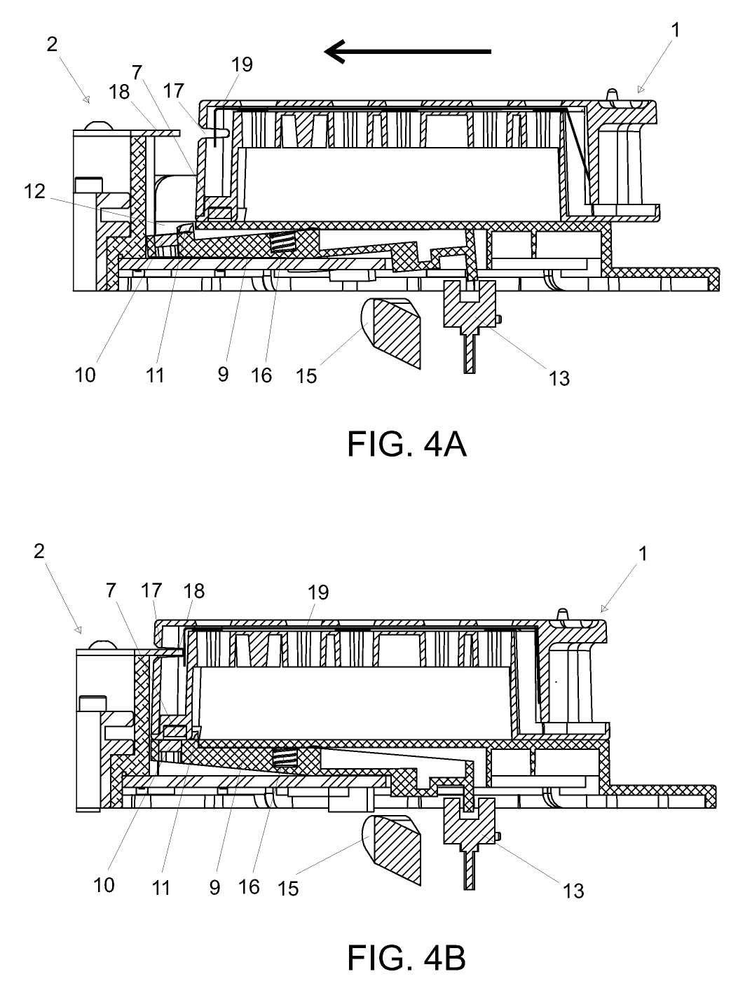

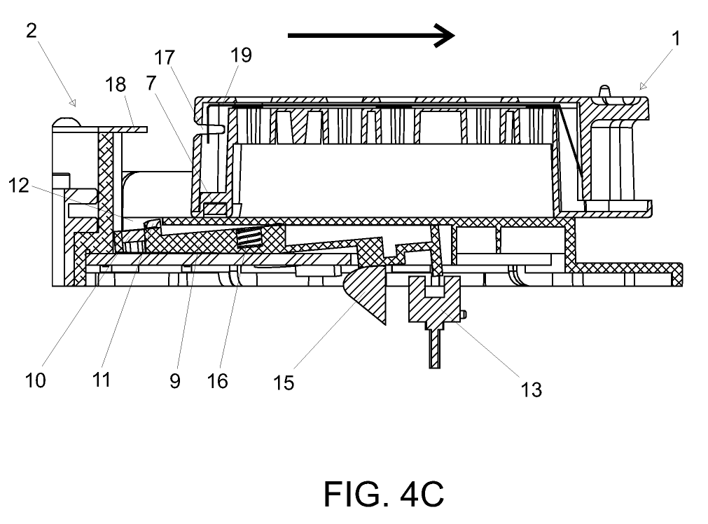

FIG. 2 shows bottom view of the sample vessel rack 1 of FIG. 1, which shows magnet 7 embedded in the bottom of the tip portion of the sample vessel rack, and side protrusions 8 extending from sides of the frame of the sample vessel rack. The magnet 7 and side protrusions 8 are used for securely attaching and properly positioning the sample vessel rack 1 in the slot 4 of the sample carousel of the analyzer instrument by vertically locking the back end of the rack. A slot 17 in the tip area of the sample vessel rack 1, which slot is used to operate the locking mechanism of the sample vessels located in the sample vessel rack with a central ring 18 (best shown in FIGS. 4A-4C), is also used to lock the tip of the sample vessel rack vertically when the sample vessel rack is located in the slot 4 of the sample vessel carousel 2. At the bottom surface of the frame of the sample vessel rack 1, next to the magnet 7, are formed notches 37 for receiving movable locking means for locking the sample vessel rack at its place in the slot 4.

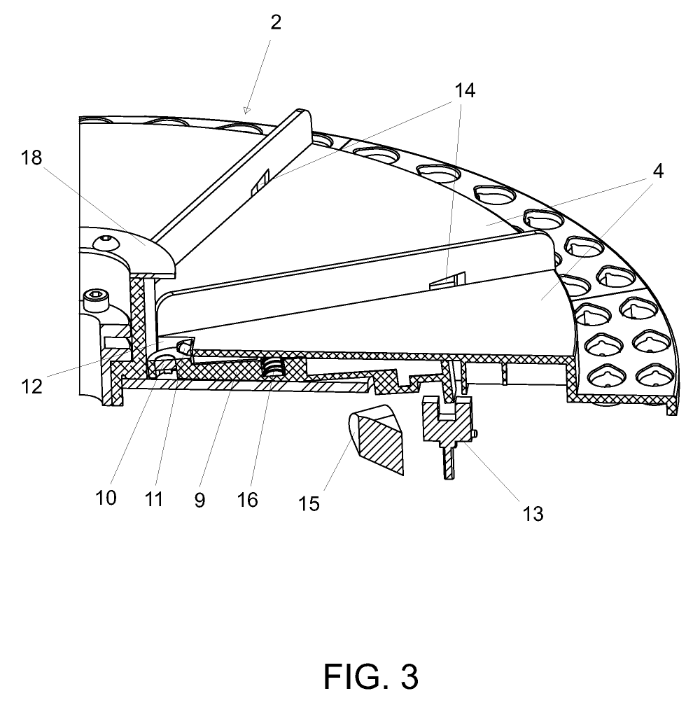

FIG. 3 shows cross-section of the sample carousel 2. This figure illustrates the locking mechanism for the sample vessel rack 1, which comprises movable member in the form of a lever 9. The lever 9 has a magnet 10 embedded at one end, which magnet co-operates with the magnet 7 of the sample vessel rack 1 for attaching and properly positioning the sample vessel rack in the slot 4 of the sample carousel 2. In the same end of the lever 9, in close vicinity of the magnet 10, is formed a protrusion 11. The protrusion 11 together with the magnet 10 is located in the area of an opening 12 formed at the bottom of the slot 4, through which opening the magnet and the protrusion can affect and access the sample vessel rack 1 located in the slot 4.

At an opposite end of the lever 9 is located an optical fork sensor 13, which is used to observe the locking position of the lever 9, so that signal for the operating system of the analyzer instrument can be generated when the lever 9 is in a locking position. The lever 9 is also equipped with a spring 16, which keeps the lever in released position when no magnetic attraction force is affecting the lever, so that the possibility of creation of an incorrect locking signal via the optical fork sensor 13 can be prevented.

FIG. 3 also shows openings 14 formed in the side surfaces of the slots 4 of the sample carousel 2, which openings co-operate together with the protrusions 8 of the sample vessel rack 1 for assisting in the attachment of the sample vessel rack in the sample carousel by guiding the rack positioning and attaching its back end vertically.

FIGS. 4A-4C shows the different stages of the insertion and removal of the sample vessel rack 1 from the sample carousel 2.

In FIG. 4A the sample vessel rack 1 is moved in the direction of the arrow along the bottom on the slot 4 of the sample vessel carousel 2, so that the end with the magnet 7 approaches the center area of the sample carousel.

In FIG. 4B the sample vessel rack 1 has reached the proper position in the slot 4 and the locking have taken place via magnetic attraction force between magnets 7 and 10. The lever 9 has moved to a locking position where the protrusion 11 is received in a notch formed in the frame of the sample vessel rack 1, and thus locks the rack on the slot 4 horizontally.

In this locking position a section at the opposite end of the lever 9 in relation to the location of the magnet 10 is set in the area of the optical fork sensor 13, thus causing the generation of a signal to the operating system of the analyzer instrument that the sample vessel rack 1 is correctly inserted in the carousel 2.

In FIG. 4C the distance between the magnets 7 and 10 is increased by pushing the lever 9 with a part 15 of an unlocking device, which significantly weakens the magnetic attraction force between the magnets, and which moves the protrusion 11 from the notch of the frame of the sample vessel rack 1. Now the sample vessel rack can be removed from the sample carousel 2 by moving it in the direction of the arrow.

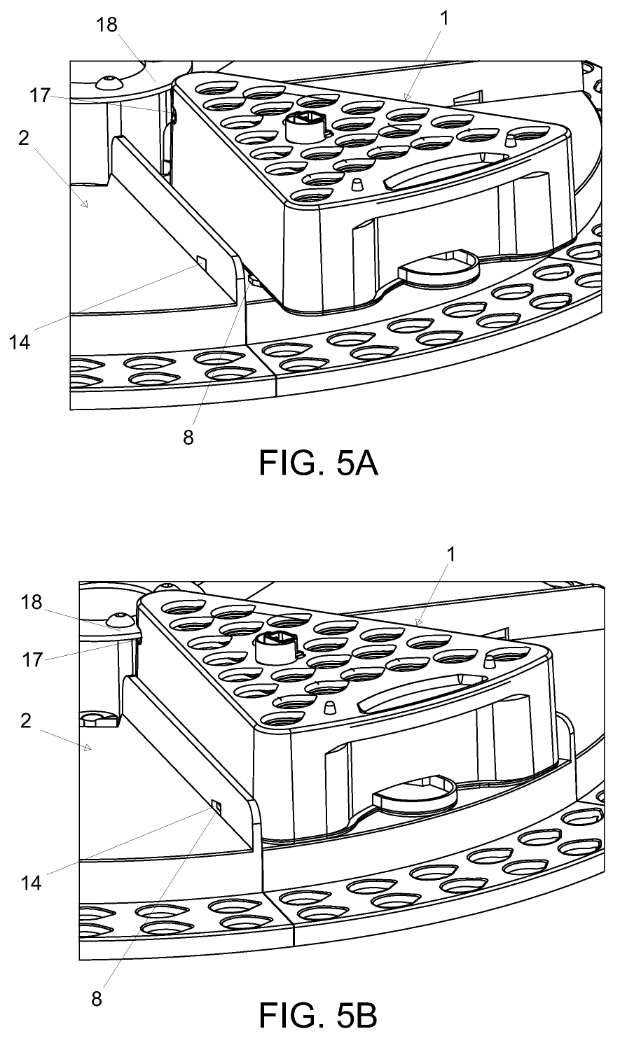

FIGS. 5A and 5B show more closely the operation and effect of the side protrusions 8 in the symmetrically formed frame of the sample vessel rack 1, which vertically lock and guide the sample vessel rack when inserted in the slot 4. FIG. 5A shows the sample vessel rack 1 in a detached position and FIG. 5B shows the sample vessel rack 1 in an attached position in relation to the sample carousel 2.

Once the rack 1 is pushed at its position in horizontal direction along the bottom surface of the slot 4 of the sample carousel 2, the symmetrical side protrusions 8 set themselves in the openings or depressions 14 formed in the side surfaces of the slot 4. The side protrusions 8, once in the openings or depressions 14, provide locking in vertical direction for the sample vessel rack 1.

In the embodiment shown in the figures, one of the magnets 7 and 10 may be replaced with a magnetically attractable metallic material. However, use of two magnets achieves stronger magnetic attraction forces and thus a better positioning effect for the sample vessel rack 1 in the slot 4.

In the locked position of the sample vessel rack 1 in the slot 4, as best shown in FIG. 4B, the magnets 7 and 10 are preferably not located horizontally concentric in relation to each other, but the magnet 10 is located closer to the center of the sample carousel 2 than the magnet 7 of the sample vessel rack 1. This way the magnetic attraction force between the magnets 7 and 10 also includes horizontal component, which actively draws the rack towards the center of the sample carousel 2 also in the locked position and thus removes any play and tolerances between the frame of the sample vessel rack 1 and slot 4. Thus positioning of the sample vessel rack 1 is always correct in relation to the slot 4. The horizontal difference in concentricity of the magnets 7 and 10 can be 1 mm, for example.

The locking plate member 19 of the sample vessel rack 1 shown in FIGS. 4A-4C locks the sample vessels in the sample vessel rack when the rack is removed from the slot 4 of the sample carousel 2. The locking plate member 19 is pushed to an unlocked position with the central ring 18 via the slot 17 in the frame of the sample vessel rack 1. This movement of the locking plate member 19 to the unlocked position happens preferably so, that when the sample vessel rack 1 is inserted in the slot 4 first a primary spring member with a smaller spring force formed at the back end of the locking plate member bends to allow the movement of the locking plate member to the unlocked position, after which a secondary spring member with a greater spring force formed at the front end of the locking plate member and in contact with the central ring 18 is pushed to a stressed state. When the sample vessel rack 1 is removed from the slot 4, first the stress of the secondary spring member is released, due to its greater spring force, before the primary spring member moves the locking plate member 19 to a locked position. The secondary spring member allows greater play between the sample vessel rack 1 and the protrusion 11 of the lever 9, without movement of the locking plate member 19 into the sample vessel locking position.

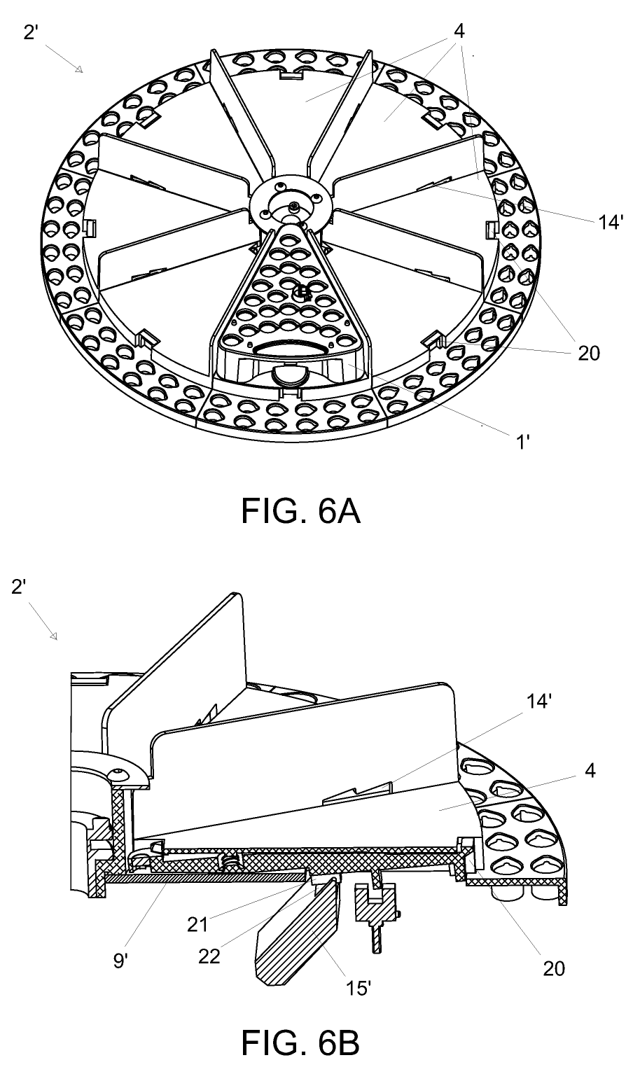

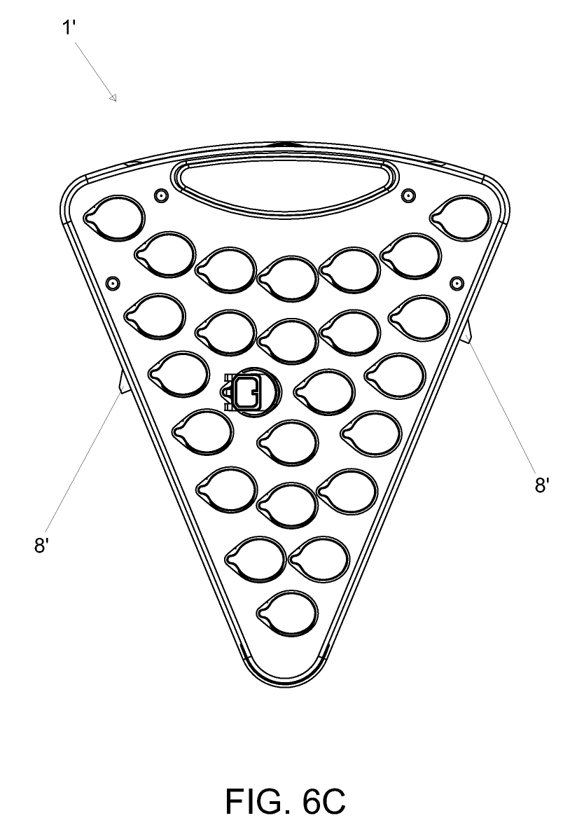

FIGS. 6A and 6B show schematically an alternative embodiment of a part of an apparatus of the invention, which in most parts corresponds to the embodiment shown in FIG. 1 and FIGS. 3A-5B, with the following additional features. FIG. 6A shows a sample carousel 2′ of an analyzer instrument with a sample vessel rack 1′ located in one of the slots 4 of the carousel, and FIG. 6B shows a cross-sectional view in the area of the slot 4 of the sample carousel 2′. FIG. 6C shows bottom view of the sample vessel rack 1′ used in this embodiment of the sample carousel 2′.

In this embodiment the lever 9′ extends all the way to the notch formed in the outer edge of the slot 4, so that a releasing extension 20 is available to a user for manually releasing the locking of the sample vessel rack 1′ in the case of malfunctioning of the analyzer instrument.

Further, at the lower surface of the lever 9′ is formed a locking extension 21. This locking extension 21 is formed to fit in a notch 22 formed in the part 15′ of the unlocking device. The locking extension 21 allows the locking of the rotating movement of the sample carousel 2′ without releasing the locking of the sample vessel rack 1′ in the slot 4.

The openings 14′ are formed so in this embodiment that the opening 14′ in one sidewall of slot 4 consists of two consecutive openings for the side protrusions 8′ of the sample vessel rack 1′. Further, the side protrusions 8′ of the sample vessel rack 1′ may preferably be formed to extend longer outwards from the side of the rack 1′ so that a small movement of the sample vessel rack 1′ is allowed before the vertical locking provided by them is removed. As can be seen from FIG. 6C, the side protrusions 8′ in this embodiment of sample vessel rack 1′ do not have the same location on both sides of the sample vessel rack 1′, i.e. the distance of side protrusions 8′ from the tip area of the sample vessel rack 1′ is not the same on both sides of the rack. This allows use of longer side protrusions 8′ and thus more support surface via these protrusions, and possibility for using thinner side walls of the slots 4, since the side protrusions 8′ of the adjacent sample vessel racks 1′ in the sample carousel 2′ do not coincide. Similarly there could be two separate openings in the same sidewall of the slot 4 used along with the asymmetrical positioning of the side protrusions 8′.

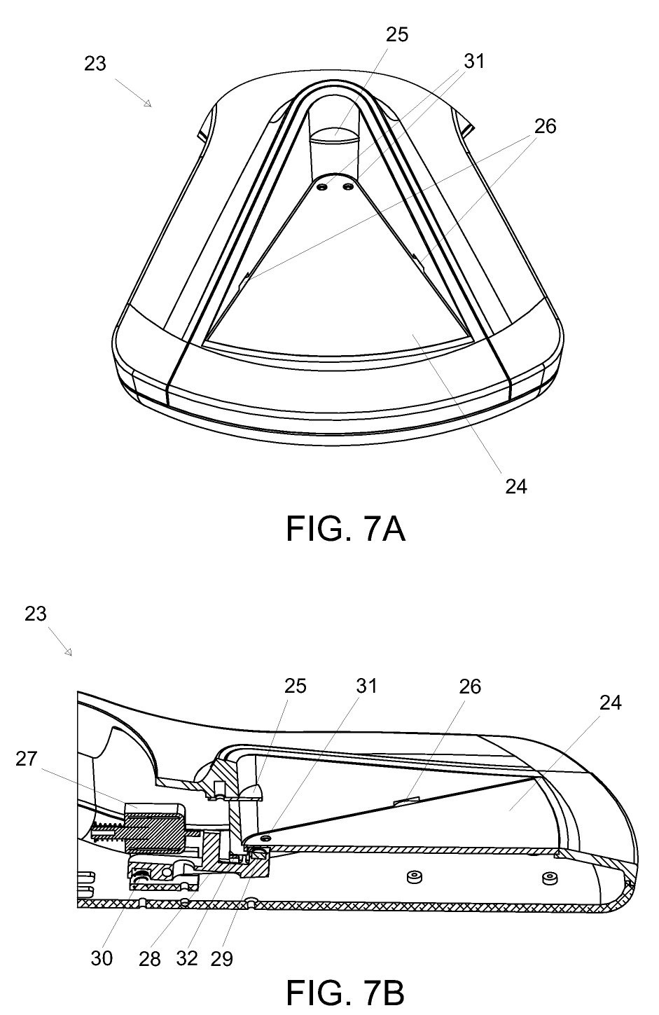

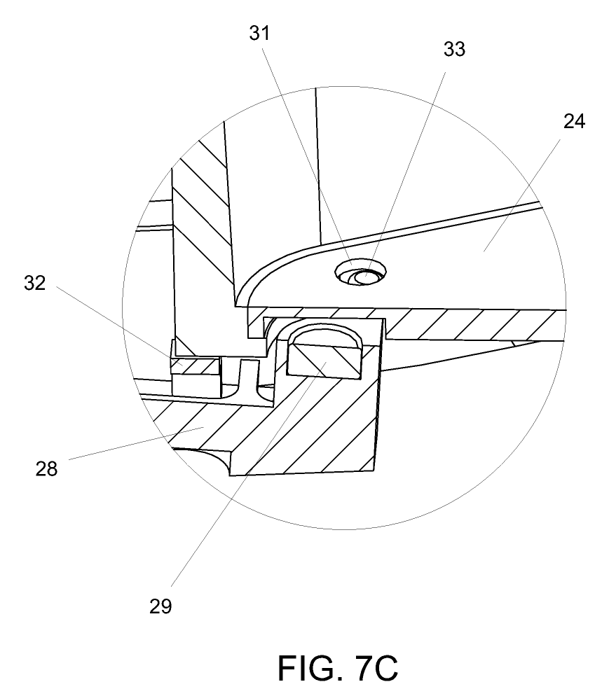

FIGS. 7A-7C show an embodiment of the apparatus of the invention, which apparatus in this embodiment is a sample preparation station 23. FIG. 7A shows a part of the sample preparation station 23 comprising a slot 24 for a sample vessel rack 1, such as shown in other figures for example, FIG. 7B shows cross-section of the part shown in FIG. 7A, and FIG. 7C shows partial enlargement of the tip area of slot 24.

Similarly than in previously discussed embodiments, the slot 24 comprises releasing protrusion 25 (a plate corresponding to the central ring plate 18 in other embodiments) for releasing the locking of the sample vessels in the sample vessel rack once the rack is inserted in the slot locking the tip of the rack vertically, and openings or depressions 26 for the side protrusions of the sample vessel rack.

The locking mechanism in this embodiment comprises solenoid 27, which operates the lever 28 having a magnet 29 in one end and optionally a spring 30 at another end. Protrusions 33 formed in the lever 28 near the magnet 29 extend through the openings 31 when the lever is in the locking position to lock the sample vessel rack at its position in the slot 24, similarly than in other described embodiments.

The apparatus also comprises an optical sensor 32 for detecting the position of the lever 28 and providing that information to the operating system of the sample preparation station.

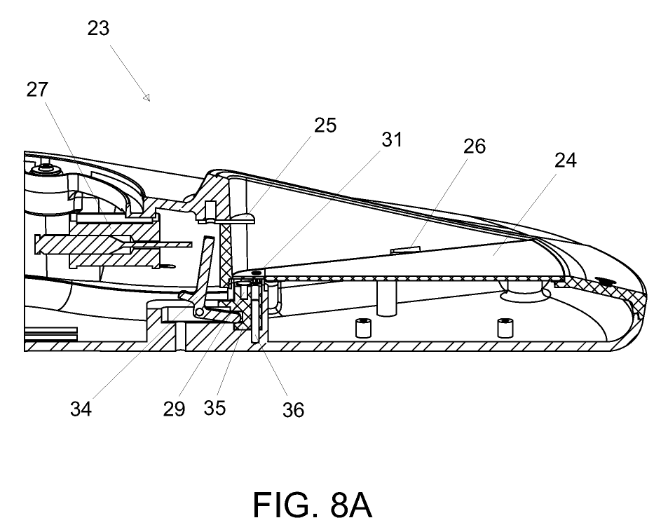

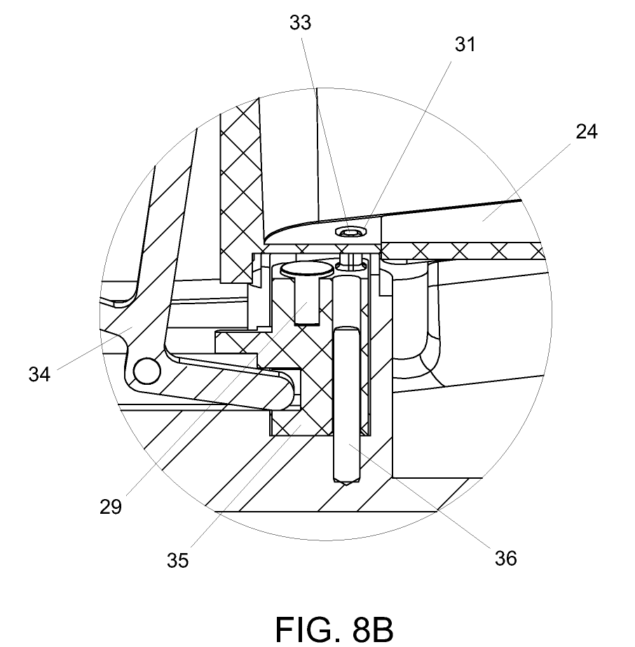

FIGS. 8A and 8B show another embodiment of the apparatus of the invention, which apparatus in this embodiment is a sample preparation station 23 that substantially corresponds to the one shown in FIGS. 7A-7C and discussed above, and same reference numerals are used for the same features. Thus only the differing features of the locking mechanism in comparison to the embodiment of FIGS. 7A-7C are discussed in more detail relation to this embodiment. FIG. 8A shows a cross-section of a part of the sample preparation station 23 comprising a slot 24 for a sample vessel rack 1, such as shown in FIG. 7A for example, and FIG. 8B shows partial enlargement of the tip area of slot 24.

The locking mechanism in this embodiment comprises solenoid 27, which operates the lever 34. Lever 34 moves a movable member 35, which is movable in linear vertical direction. The movement of the movable member 35 is guided with a guide pin 36. The movable member 35 comprises a magnet 29 which cooperates with a magnet or metal piece in the frame of a sample vessel rack inserted in the slot 24 to move the movable member upwards in a locking position, in which locking position the protrusions 33 formed in the movable member extend above the outer surface of the slot 24 via openings 31.

In relation to the embodiment of the figures, which discloses the present invention as applied to an analyzer instrument via a sample carousel and sample preparation station, it is to be noted that the present invention may also be implemented to other similar devices used with sample vessel racks substantially similarly or with simple modifications evident to a person skilled in the art.

The specific exemplifying embodiment of the invention shown in figures and discussed above should not be construed as limiting. A person skilled in the art can amend and modify the embodiment in many evident ways within the scope of the attached claims. Thus the invention is not limited merely to the embodiment described above.

1. A method for attaching a sample vessel rack in an apparatus, wherein the apparatus comprises a slot into which the sample vessel rack is inserted, wherein a magnetic attraction force is utilized in the attachment and correct positioning of the sample vessel rack into the slot, wherein the slot comprises a movable member, wherein the movable member is moved to a locking position with the magnetic attraction force when the sample vessel rack is in a correct position in the slot, and wherein the movable member comprises at least one protrusion wherein the protrusion sets itself in a notch formed in the sample vessel rack in a locking position of the movable member.

2. The method according to claim 1, wherein the sample vessel rack comprises protrusions or openings which co-operate with corresponding openings or protrusions in the slot together with the magnetic attraction force for attaching the sample vessel rack in the slot.

3. The method according to claim 1, wherein the movable member causes a generation of a signal when the movable member is in a locking position.

4. The method according to claim 1, wherein the locking of a sample vessel in the sample vessel rack is released during the insertion of the sample vessel rack in the slot.

5. A sample vessel rack for a plurality of sample vessels, wherein the sample vessel rack comprises a frame, at least one magnet for attaching and properly positioning the sample vessel rack in an apparatus, wherein the frame of the sample vessel rack further comprises protrusions or openings for attaching and properly positioning the sample vessel rack in the apparatus, and a notch for receiving the movable member for locking the sample vessel rack to the apparatus.

6. The sample vessel rack according to claim 5, wherein the protrusions or openings are arranged asymmetrically in the opposite sides of the sample vessel rack.

7. The sample vessel rack according to claim 5, wherein the sample vessel rack has substantially triangular form in a plane perpendicular in relation to the insertion direction of the sample vessels.

8. An apparatus for a sample vessel rack, wherein the apparatus comprises a slot for inserting the sample vessel rack, wherein the slot comprises a first magnet or a magnetic metal piece which co-operates with at least a second magnet or magnetic metal piece located in the sample vessel rack for attaching and properly positioning the sample vessel rack inserted into the slot, wherein the first magnet or magnetic metal piece is located in a movable member, wherein the movable member comprises at least one protrusion, and wherein the at least one protrusion is located in a notch in the sample vessel rack when the movable member is in a locking position.

9. The apparatus according to claim 8, wherein the slot comprises a first opening or protrusion for corresponding a second opening and protrusion in the sample vessel rack for attaching and properly positioning the sample vessel rack in the slot.

10. The apparatus according to claim 8, wherein the movable member comprises a mechanism for causing the generation of a signal when the movable member is in a locking position.

11. The apparatus of claim 8, wherein the slot comprises a mechanism for releasing a locking mechanism when the sample vessel rack is located in the slot, the locking mechanism maintaining one or more sample vessel in place in the sample vessel rack.

12. The apparatus of claim 8, wherein the apparatus is an analyzer instrument or a sample preparation station.

13. A method of using the sample vessel rack of claim 5 in the apparatus.
